(19) United States
(12) Patent Application Publication
(10) Pub. No.: US 2012/0166278 A1
(43) Pub. Date: Jun. 28, 2012

(54) METHODS AND SYSTEMS FOR CREATING SELF-LEARNING, CONTEXTUALLY RELEVANT, TARGETED, MARKETING CAMPAIGNS, IN REAL TIME AND PREDICTIVE MODES

(76) Inventors: Malcolm MacGregor, Bainbridge Island, WA (US); Randy Browning, Mercer Island, WA (US); Joseph Mouhanna, Bothell, WA (US); John Kottcamp, Seattle, WA (US)

(21) Appl. No.: 13/316,788

(22) Filed: Dec. 12, 2011

Related U.S. Application Data
(60) Provisional application No. 61/422,102, filed on Dec. 10, 2010.

(51) Int. Cl. G06Q 30/02

(52) U.S. Cl. 705/14.49

(57) ABSTRACT

The current application is related to the creation of real time as well as predictive marketing campaigns, in particular, through the identification of contextually relevant data channels and sources, harvesting data and media from channels and sources, categorizing the data, classifying the data authorship type and influence levels, ranking by the data based on context, and using the data to produce, disseminate, monitor/track, and quantify results for real-time as well as predictive marketing campaigns.

### CROSS-REFERENCE TO RELATED APPLICATION

This application claims the benefit of Provisional Application No. 61/422,102, filed Dec. 10, 2010.

### BACKGROUND

The influence in marketing has changed from brands broadcasting out to peer-influence. With widespread home, car, flat-screen, and smart-phone ownership, many of us are now self-defining with likeminded people. We are more likely to listen to peers than be influenced by brands.

The Internet has enabled us to influence companies. We can now create sell-out demand for products before any marketing happens. Our individual voices now have a chance to influence.

Brands are reacting to this change by: 1) Monitoring the status of their brands and responding in an ad-hoc one-to-one context; 2) Setting up base camps in Facebook; 3) Creating engaging content in a hit-or-miss methodology; 4) Taking advantage of the context of the environment in which they are deploying (insert a generic message in a Twitter music trend or insert a music ad in a Pandora stream or in a Google search).

Brands lack a process to develop contextualized content that can be inserted in the same contextual conversation where influence thrives.

Client marketing organizations have difficulty creating an integrated message in the marketplace that builds on itself across any channel combination with the ability to be assessed by channel.

Fast turnaround remains elusive. A web experience project requires 6 months lead time. A retail campaign requires 2 months. This disparate timing makes it hard for one central idea to define integration. Secondly, each channel manager guards the expertise of their channel so as to not lose control. This makes the choices of success of traditional integration efforts remote.

Clients and agencies have tried driving integration from brand campaign down, CRM up, from 6 months forward and around the last step of production. Whichever way integration is attempted, it hasn't really worked.

Marketers set campaign strategy months upfront and execute accordingly. They can only react to real-time inputs in a crisis management manner. This model is now outdated given how people's decision-making patterns have recently evolved to live in real-time.

The Internet has enabled real-time conversation on a massive scale allowing individuals to become aware, research, consider and purchase in hours and minutes versus days, weeks or months. Marketers must be participating in this real-time purchase funnel timeframe or else they will lose traction in persuading the decision making process.

Research and strategy: For brand advertising, qualitative research typically sets three months out and its outcomes are based on a group of 12 or so respondents that are being paid for their participation. For direct marketing, data mining research is used to identify behavior analysis based on past functional tendencies. What is missing from both approaches is what we do intuitively as people. We react to our environment and the context of the current conversation.

Creative, production and publishing: Currently, agency the creative, production and publishing processes are discrete. The creative process is all about developing afresh. Every time a project is initiated, the aim is to custom create a bespoke solution. The production process takes the creative and rebuilds it as a deployable asset, in essence duplicating the creative process. Then to publish, the asset is typically processed through multiple internal departments adding time and costs.

Current advertising agencies make revenue based on a service model charged by number of employees it takes to deliver an agreed scope of work. All IP, thinking and work an agency does on behalf of its clients belongs to those clients. Agency long-term value is based on reputation, a portfolio of clients' work, and knowledge residing in individuals who might or might not leave.

There is no current ability to build massive data-storage populated with agency-owned data regarding what's important to people, how they interact and make decisions. There is no ability to break down the FTE heavy structure and process inherent in making money to action campaigns in 72 hours or less.

There is no ability to scale beyond tens of clients. There is no ability to use data collection to normalize between channels and determine a predictability regarding where and how to best spend marketing funds. Agencies today develop client rosters based on cultural fit, revenue limitations, geographic limitations, and reputation. Agencies don't identify specific categories and set out to become experts in these categories as a cable broadcaster might, because there is no way of amassing long category term IP. Agencies do not build and curate influencer communities within specific categories with the purpose of creating a category network that is ripe to consume and proliferate publishing.

### SUMMARY

The current application is related to the creation of real time as well as predictive marketing campaigns, in particular, through the identification of contextually relevant data channels and sources, harvesting data and media from channels and sources, categorizing the data, classifying the data authorship type and influence levels, ranking by the data based on context, and using the data to produce, disseminate, monitor/track, and quantify results for real-time as well as predictive marketing campaigns.

### BRIEF DESCRIPTION OF THE DRAWINGS

FIG. 1 illustrates the overall architecture.

FIG. 2 illustrates the higher level architecture of the data collection, training models generation, and analysis modules.

FIG. 3 illustrates the training sets generation process

FIG. 4 illustrates the hourly date collection process.

FIG. 5 illustrates the Categorized TTCs Generation process.

FIG. 6 illustrates the Categorized Type-specific TTCs Generation process.

FIG. 7 illustrates Data Collection TTC feedback Loop process.

### DETAILED DESCRIPTION

Embodiments of the present invention are directed to methods and systems for enabling, but not limited to, marketing professionals and ad agencies to create real-time, as well as predictive (planned to take place in the future, based on trends predicted by the methods and systems) marketing campaigns, targeted at and delivered to specific consumer segments.

This provides for:
Unfiltered real-time and contextually relevant trends derived from a category culture.
Relevant and actionable real-time insights that facilitate multichannel production and publishing.
Ability to determine trend power across competitors, peers, publishers, influencers and channels.
Campaign and multichannel ROI with predictive marketing mix capability.
High velocity endorsement publishing with the influencer network.

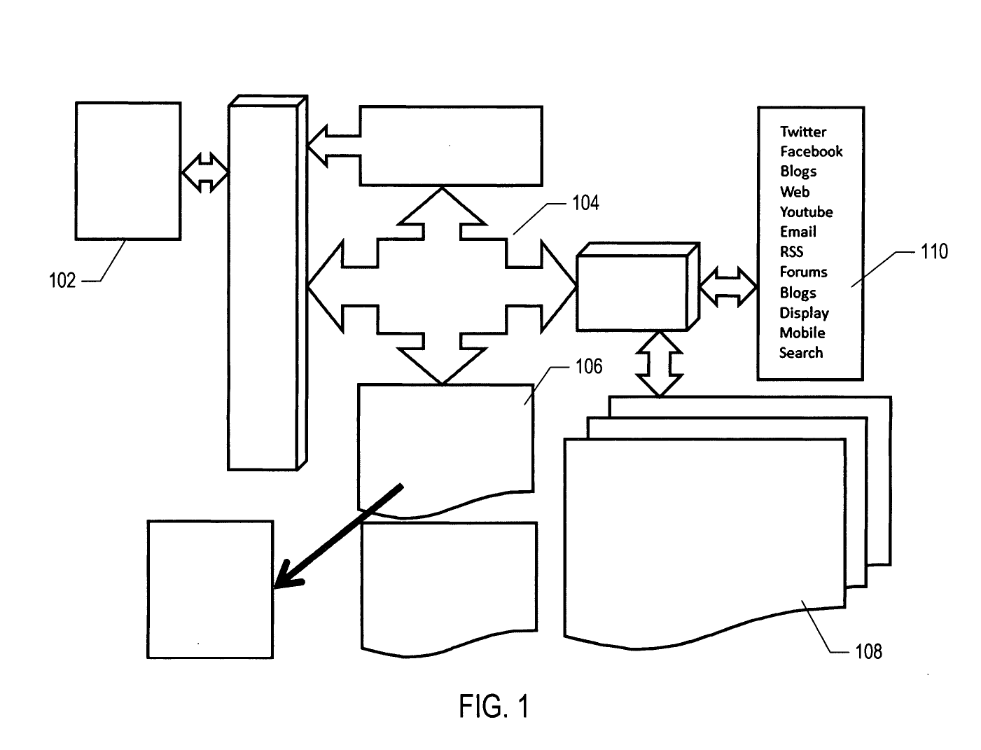

FIG. 1 provides an overview of the main architectural blocks. Data from various web and social media sources 102 is collected and used to build self-learning training models, as well as analyze 104 for the purpose of categorization 106, type identification and trend generation. This information is then used to develop marketing campaigns 108, and disseminate through the various channels 110.

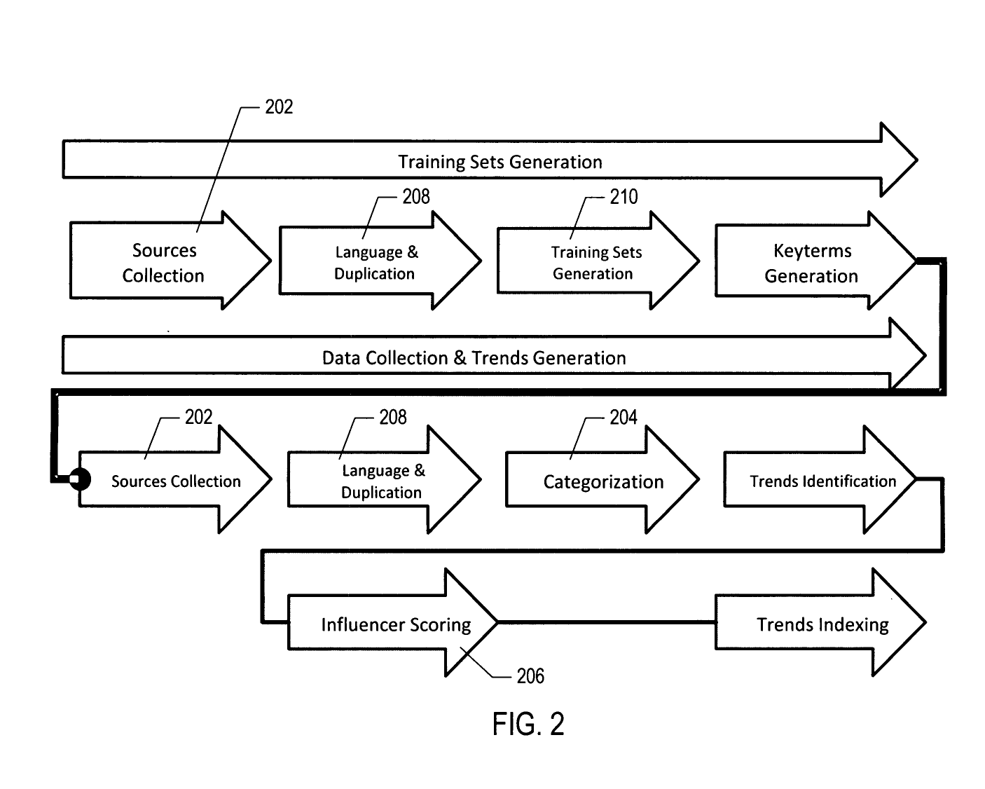

The first step in the system is trend generation and training sets generation, as illustrated in FIG. 2. This is accomplished through Collection of data/media 202, running it through training sets to categorize (music, sports, cars, etc.) 204, and influencer identification 206 (a person or entity whose opinion is respected and followed in this space); A feedback loop passes the right data through NLP (natural language processing) filters 208, to create and keep the learning models up to date. Trends, in the form of three term combinations (TTCs) based on category, data source, and type are generated and stored in hourly chunks in the database 210. The TTCs represent the most popular terms used in that particular hour, based on context.

The remaining modules use the stored TTCs to generate reports, notify system subscribers, create advertising materials, and disseminate the resulting “campaigns” to through the selected channels.

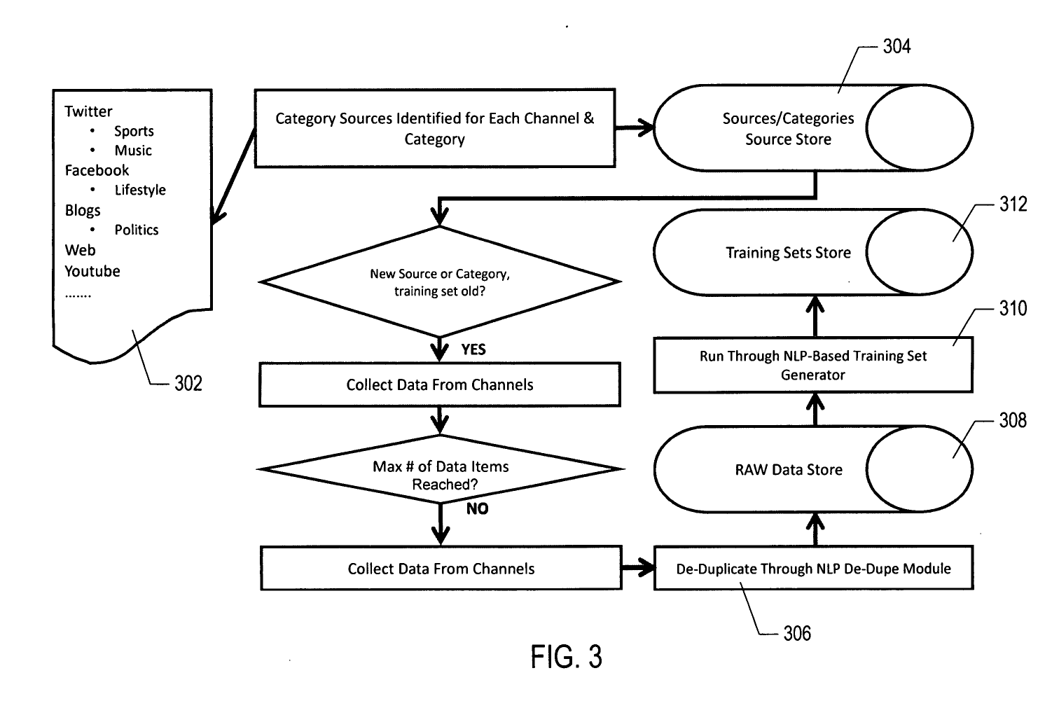

The process starts with Training Sets Generation, as illustrated in FIG. 3.

Blab Marketing and Business Development personnel identify resources (web sites, facebook pages, twitter hashtags, blogs, etc. 302 and enter these resources into the category sources store. FIG. 304.

The category sources store is used as an input to data collection process. Data format: 1. Category: Cars, Weddings, etc.; 2. Source: Twitter, Facebook, Blog, Web; 3. Resource: Channel (Twitter, Facebook, etc.); 4. Type: Professional, Competitor, Influencer (peer is not included, because it's determined through an exclusion algorithm). Note: Influencer is automatically generated (with the possibility of manually adding influencers), the other type definitions are manually-generated.; 5. Frequency: How often should data is refreshed in days; 6. Max # of items per source/category. FIG. 3.

When a change is made to a source/category, as in adding or deleting a new resource, the formula for filling the database is as follows:

ch = new resource entered;
e = existing number of resources;
n = new number of resources;
m = max # of data items;
d = # of data items per resource;
f = frequency;
t = time a resource was last updated;
c = current time;
if ( ch ) {

if ( n > e ) {

d = n − e;
direction = negative;

} else {

d = e − n;
direction = positive;

}
If (direction == positive) {

m = m + d;

} else {

```
  Delete d # of entries in
  Category/resource table
  Sorted by oldest;
  }
```

}

}

Data collected goes through the Natural Language Processing module 306 responsible for de-duplication. The parameters for this module are set specifically for each channel type, as well as category. Results are stored in the Raw Data data store. FIG. 308.

Data from the Raw Data Store is run through the training set NLP training set generator 310. What is not in-category, is considered out-of-category. The resulting training sets are stored in the training sets data store. FIG. 312.

Hourly data collection is the next step in the process. Channels (Facebook, Twitter, etc) are selected by Blab, and added to the Channels Data Store. The Data Collectors call their respective Channel APIs and start collecting data. All data is sent to the General Data Store, and kept for archival purposes, identified by epoch hour.

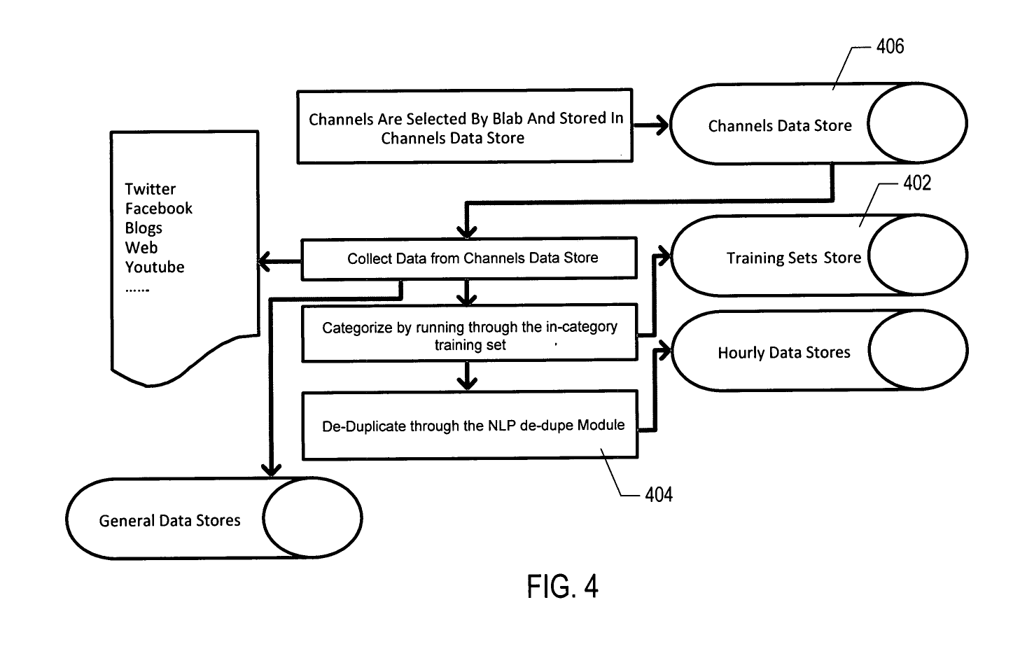

FIG. 4. Categorized Hourly Data Collection. In parallel, each piece of data is sent to through the NLP category classifier, which uses the in-category and out-of-category training sets stored in the Training Sets Data Store 402 to determine a category. The data is processed in hourly chunks, and cached. The hourly chunk is then de-duped using the NLP de-dupe module 404, which eliminates duplicates based on “similarity” vis-à-vis the context, rather than exact duplicate. The results are stored in the Hourly Data Stores 406, categorized, per Channel.

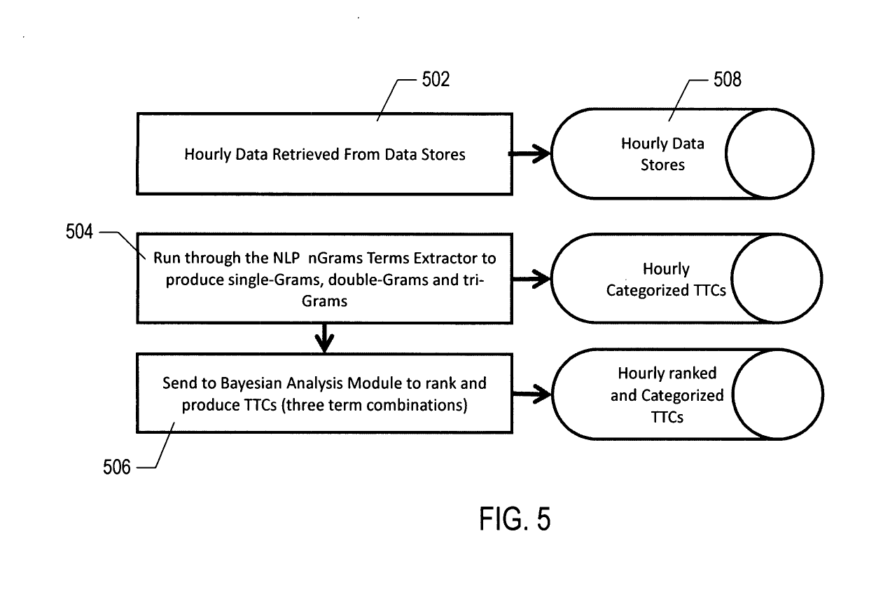

As shown in FIG. 5, Categorized TTCs Generation Hourly Data Retrieved From Categorized Hourly Data Store 502. It is then run through the NLP nGrams Terms Extractor 504 to produce single-Grams, double-Grams and tri-Grams, with their associated metadata in JSON format. The JSON is sent to the Bayesian Analysis Module 506 to rank and produce hourly categorized and ranked TTC files (three term combinations). They are stored in the Hourly Categorized TTCs Data Store 508.

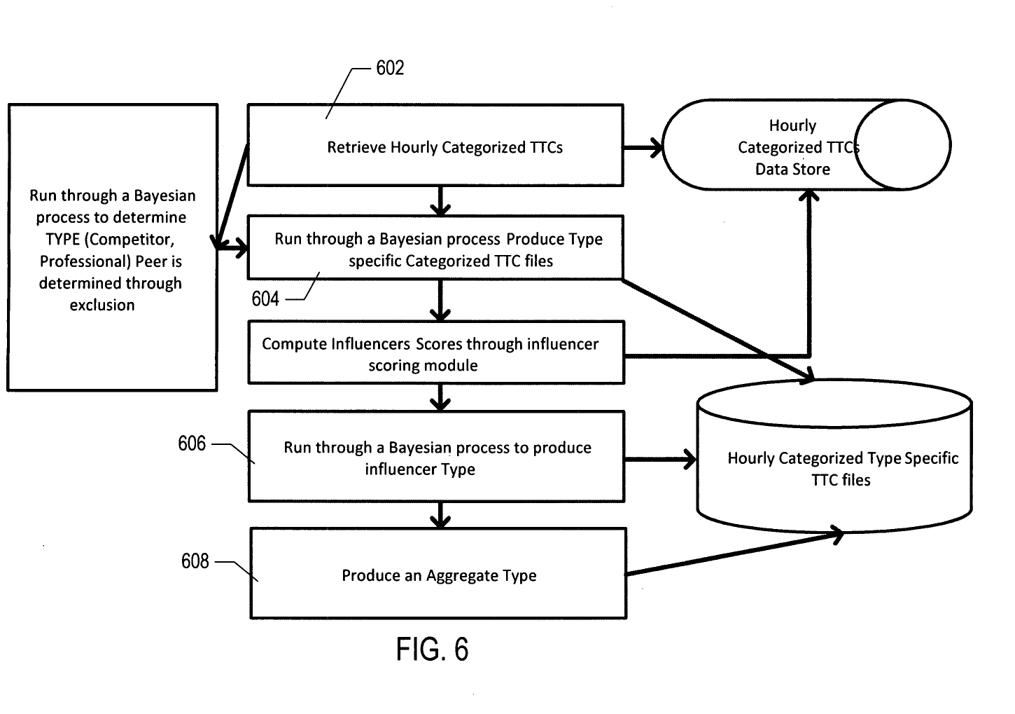

FIG. 6. Categorized Type-specific TTCs Generation process. Hourly Categorized TTCs are retrieved from the data store 602 and run through a Bayesian process 604 to determine TYPE (Competitor, Professional) Peer is determined through exclusion whereby anything left over after competitor and professional is considered peer. The resulting data is run through a Bayesian process to Produce Type-specific Categorized and ranked TTC files 606. Influencers Score is computed and the data is run through the Bayesian process to produce an influencer-specific ranked TTC file. Finally an aggregate type is produced 604 through an aggregation process of all the other types.

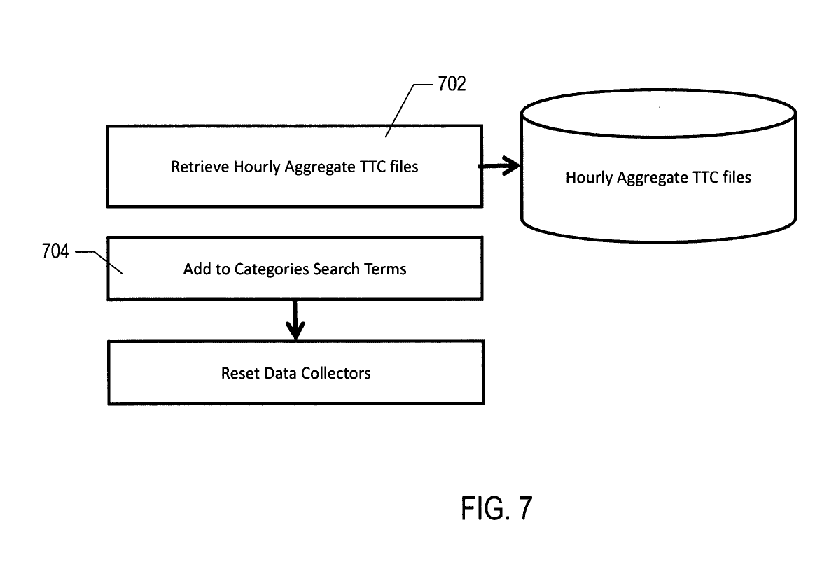

FIG. 7—Data Collection TTC feedback Loop process. Data Collectors search through Channels for data using search terms stored in the search terms table. This is an organically fed table as described in this process. Top ranking TTCs are retrieved from the hourly TTC files 702, per channel and per category. TTCs are parsed out from this JSON file, and added to the search 704. On hourly basis, the collectors reset their search terms and retrieve the new search terms from this table. When they restart, they are collecting data that is more relevant and within the context of each channel/category. This is self-feeding loop, allowing the system to learn and increase its efficiency and accuracy.

Although the present invention has been described in terms of particular embodiments, it is not intended that the invention be limited to these embodiments. Modifications within the spirit of the invention will be apparent to those skilled in the art.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system that creates real time as well as predictive marketing campaigns by:
identifying contextually relevant data channels and sources;
harvesting data and media from channels and sources;
categorizing the data;
classifying the data authorship type and influence levels;
ranking by the data based on context; and
using the data to produce, disseminate, monitor/track, and quantify results for real-time as well as predictive marketing campaigns.
